(19) United States
(12) Patent Application Publication
(10) Pub. No.: US 2011/0259244 A1
(43) Pub. Date: Oct. 27, 2011

(54) Nanoparticulate Titanium Dioxide Particles with a Crystalline Core, a Metal-Oxide Shell and an Outer Skin Containing Organic Groups, and Method for the Manufacture Thereof

(75) Inventors: Bettina Herbig, Thuengersheim (DE); Gerhard Schottner, Heilsbronn (DE)

(73) Assignee: Fraunhofer-Gesellschaft zur Foerderung der angewandlen Forschung e.V., Muenchen (DE)

(21) Appl. No.: 13/141,523

(22) PCT Filed: Dec. 18, 2009
(86) PCT No.: PCT/EP2009/067574

§ 371 Date: Jun. 22, 2011

(30) Foreign Application Priority Data
Dec. 23, 2008 (DE) 10 2008 062 969.3
May 29, 2009 (EP) 09161600.3
Dec. 18, 2009 (EP) PCT/EP2009/067574

(51) Int. Cl. C04B 14/30; B05D 7/24; B82Y 99/00

(52) U.S. Cl. 106/448; 106/447; 427/214; 977/773

(57) ABSTRACT

This invention refers to particles with a crystalline core of titanium dioxide that has an average diameter of ≦30 nm measured with the XRD/Scherrer method, a shell made of a metal oxide that has no photocatalytic properties and an outer skin that carries organic radicals. A suspension of these particles is conveniently prepared with a process that encompasses the following steps: The supply of a dispersion that has crystalline titanium dioxide particles having an average diameter of ≦30 nm whose surface has been modified with organic groups in solution that contains a dissolved, hydrolytically condensable compound of a metal M whose oxide should form the shell mentioned above, in which case an organic solvent or a mixture of an organic solvent and water is used as solvent, and adjusting the pH of the solution in such a way that a full deagglomeration of the nanoparticles occurs, the stirring of the dispersion in the presence of a sufficient quantity of water for the hydrolytic condensation of the dissolved, hydrolytically condensable compound of the metal M until the organic constituents with which the modified TiO₂ particles were coated are displaced, and an oxidic shell of the metal M has formed, and after preferably at least some of the solvent/water from the product obtained has been removed and a surface-modifying component of the oxidic shell and the causing of the formation of an outer skin that has organic groups with the help of this component on the particles has been added.

This invention refers to surface-modified titanium dioxide nanoparticles and dispersions of these particles as well as to processes for their production, starting from gel-like masses re-dispersed in organic solvents. Medium-range particle size (up to 30 nm and especially from approx. 5 nm) can be selectively adjusted with the help of the chosen process parameters. The stable dispersions or gels of the particles according to the invention can be supplied in a highly concentrated state due to the selected nanoparticle surface modification. In a special embodiment of the invention, surface-modified titanium dioxide nanoparticles are provided that have an oxide layer between the titanium dioxide core and the surface-modified outer skin for shielding the titanium dioxide from the surroundings. Because of this, and with the incorporation of the corresponding dispersions or nanoscale powder in organic matrices, it is possible to prevent or reduce their damage.

Nowadays, clean surfaces with “self-cleaning” properties are the object of intense research in surface technology owing to the increasing importance of photocatalytically active coatings. Titanium dioxide is a photo semiconductor, in which the formation of strongly oxidizing charge carriers is initiated due to photon absorption in the UV-A wavelength range of light. Owing to its stability and high activity, it is the most widely used photocatalyst. Nanoscale titanium dioxide has special advantages properties because of its widely available catalytic surface.

The crystallinity of the nanoparticles has a positive influence both on photocatalytic activity and on refraction index. In the field of applications based on the photocatalytic effect of titanium dioxide nanoparticles, it should therefore be as high as possible. Moreover, the self-cleaning effect of the surfaces made functional with titanium dioxide can be controlled with the size of the nanoparticles. For a series of surface technology applications (e.g. for optical objects such as lenses, spectacles or other products that must have a high refraction index), the transparency of the coating is an absolute prerequisite. Lenses with a coating that can contain TiO₂ particles are known from US 2006/0251884 A1, for example. Nanoparticle-based coatings made functional require their nanoscale availability (d<30 nm) after incorporation in the layer matrix. For producing transparent coatings—especially in the application field based on the photocatalytic effect of titanium dioxide nanoparticles—particle diameter with regard to the mean value in the Gaussian distribution curve should be below 30 m as a rule and the particles should not be in agglomerated form. The size-dependent property of the nanoparticles and the highly porous nanoparticular coatings resulting from them is also important for photovoltaic and sensory applications, for instance.

For the preceding applications, particularly in the field of photocatalysis and varnished and composites with a high refractive index, the anatase and rutile modification are important. With ideal crystallinity, the rutile modification has a lower photocatalytic activity and a higher refraction index (n≈2.7) than anatase (n≈2.55). However, the synthesis of agglomerate-free rutile nanoparticles has not been satisfactorily solved yet (milling of flame-pyrolytically manufactured powder or production in highly diluted, strongly acidic solution with wet chemical methods).

As mentioned above, a nanoscale re-dispersion ability of the nanoparticles is often required for the purpose of incorporating them into inorganic and organic layer matrices, for example. For the re-dispersion of the titanium dioxide nanoparticles in organic solvents and their incorporation into solvent-based formulations such as varnishes, resins and polymers, for example, the accessibility of solvent-based nanoparticle dispersions with a sufficiently high solid content is therefore a prerequisite.

The requirements of high nanoparticle crystallinity with simultaneous adjustable particle size, their outstanding re-dispersibility and the presence of dispersions with a high solid content have so far not materialized simultaneously.

The production of crystalline titanium dioxide nanoparticles by so-called bottom-up processes (e.g. precipitation reactions, pyrolytic processes, etc.) and top-down processes (e.g. high-energy milling of flame-pyrolytically manufactured powder) are already being used in the industry.

Titanium dioxide powders manufactured with flame pyrolysis are characterized by high crystallinity. Owing to the high temperatures of the process, however, sintering necks are formed among the particles and with them the formation of aggregates with a size range of ˜70 nm that can only be converted to a dispersion through a complex pre-dispersal under reduced energy input and subsequent milling of the pre-dispersion. The addition of surface-covering substances like at least one amino alcohol and at least a carboxylic acid (DE 102004037118 A1) should prevent the re-agglomeration of the particles or aggregates. However, the breaking up of the ˜70-nm-large aggregates is not fully successful even with intensive processes. Furthermore, the products resulting from the milling are mostly contaminated owing to the addition of grinding aids (e.g. 10-15% by volume of ZrO₂ grinding balls) that can be removed later only with great difficulty.

The production of nanoparticles from colloid-dispersed solutions (precipitation reactions based on the sol-gel process) via hydrolysis and condensation reactions of titanium alkoxides in alcoholic solutions under slightly elevated temperature are known (J. Nanosci. Nanotechnol. Vol. 6, No. 4 (2006) 906; Chem. Rev. 107 (2007) 2891). In this way, the hydrolysis of Ti(OPrⁱ)₃acac was studied in alcohol and a very large excess of water (A. Lèaustic et al., Chem. Mater. 1 (1989) 248). The particles formed in this way, whose sizes ranged from 3 to 6 nm, had properties that led one to conclude the presence of acetylacetonate groups on their surface. Comparable titanium dioxide particles with even smaller diameters were obtained by E. Scolan et al. (Chem. Mater. 10 (1998) 3217) using a similar method. The presence of the acetylacetonate groups prevented further aggregation in them, making it possible to obtain a sol with a Ti concentration of 0.5-1 M that remained stable for several months.

One way to manufacture titanium dioxide nanoparticles that can be dispersible at the nanoscale level and also have sufficiently high crystallinity is hydrothermal synthesis, which is superior to conventional precipitation methods based on the sol-gel technology. It consists of the production of crystalline titanium dioxide nanoparticles employing the thermal treatment of aqueous solutions in autoclaves and is described in numerous scientific publications and patents.

Regarding the titanium starting compound used, two different synthesis paths are possible. In most cases, titanium salts, preferably titanium halides or their solutions such as TiCl₃, TiCl₄, TiOCl₂, TiOSO₄, are used. Furthermore, the use of titanium alkoxides (Ti(OPrⁱ)₄, Ti(OBuⁿ)₄, etc.) is described.

Usually, acidic or alkaline hydrolysis of the mentioned starting compounds produces an amorphous TiO(OH)ₓ precipitate that, if applicable, is autoclaved after the washing for producing halogen-free material as a suspension. The crystalline titanium dioxide nanoparticles obtained with this method are once again in the form of a precipitate and must therefore be removed, if need be, through time-consuming filtration or centrifugation. The production of sols containing nanoparticles requires the re-dispersing of the precipitates through complex grinding and dispersal processes, if need be using ultrasound and/or the addition of dispersal aids and precise pH adjustment. These methods for the production of titanium dioxide dispersions that contain nanoparticles have been described in depth in the literature.

If the nanoparticles that underwent hydrothermal synthesis should be treated only after their production, then the approach generally suggested in DE 102004048230A1 and WO2006/037591A2 and shown with the help of ZrO₂ is advantageous. According to the information given by the authors, the particles are not modified yet after thermal or hydrothermal treatment. However, through the milling of the powder previously obtained by drying and the addition of surface-covering substances such as silanes, carboxylic acids, β-carbonyl compounds, amino acids and amines, a mechanically activated surface modification can take place in a tailor-made way for later use.

The experiments carried out in the production of crystalline titanium dioxide nanoparticles by thermal treatment of solvent-containing solutions (solvothermal synthesis) have already been described in the scientific literature and in patent applications.

Kim et al. (J. of Crystal Growth 254 (2003) 405) mixed titanium isopropylate with toluene in different weight proportions. After the solvothermal treatment of these solutions at 250° C. for 3 h, they obtained precipitates of crystalline titanium dioxide nanoparticles in the anatase modification with average particle sizes of about 11-20 nm.

M. Kang et al. (J. of Photochemistry and Photobiology A: Chemistry 144 (2001) 185) autoclaved a solution of titanium isopropylate in 1,4-butandiol at 30° C. for 1 h and likewise obtained with this method a precipitate of crystalline titanium dioxide nanoparticles in the anatase modification with particle sizes of at least 50 nm.

H. Kominami et al. (Catalysis Today 84 (2003) 181) also produced crystalline titanium dioxide nanoparticles in the anatase modification through the solvothermal treatment of titanium-n-butylate in 2-butanol. From the solvothermal treatment of the alcoholic solution, a powder of agglomerated titanium dioxide nanoparticles with an average diameter of 20 nm was obtained. Contrary to Kim et al. (see above), they obtained no product when the solvent was replaced by toluene. From this, they concluded that the water needed for hydrolysis came from the butanol.

In the sol-gel chemistry field, the stabilization of titanium compounds through the addition of chelating agents such as carboxylic acids or diketones, etc. has been researched quite well (see Inorg. Chem. Commun. 6 (2003) 102; J. Mat. Chem. 14 (2004) 3113; Mater. Res. Soc. Symp. Proc. Vol. 847 (2005) EE7.2.1; J. Chem. Soc. Dalton Trans. (1996) 3343; Chem. Mater. 1 (1989) 240).

X. Chen et al. (J. Am. Ceram. Soc. 87 [6] (2004) 1035) obtained from titanium-n-butylate a titanyl-carboxyl complex compound that could be isolated as a solid through centrifugation by adding acetic anhydride in cyclohexane and heating to 75-80° C. The complex was dispersed, heated up and stirred in plenty of water or diluted nitric acid and dissolved at various rates depending on nitric acid concentration. The reaction system was subsequently maintained pressure-free at 60° C. until full conversion. The produced crystals having particle diameters between 3 and 9 nm and a rutile and/or anatase structure were centrifuged off, washed and dried to a powder. The anatase crystals had a diameter between 4 and 6 nm.

Jitputti et al. (J. Solid State Chem. 180 (2007) 1743) complexed titanium butylate after adding ethanol and water with acetylacetone (Ti:Acac=1:1) (130° C., 12 h). They obtained a product mix that was dried with isopropanol in the oven after washing. Radiographic analyses showed that the isolated powder consisted of titanium dioxide nanoparticlesin of the anatase modification with a particle size of 8.2 nm.

DE 10 2006 032 755 A1 describes the production of stable dispersions of nanoparticles. To do this, a titanium alkoxide is complexed/chelated in a solvent having a polar compound as in EP 1 045 015 A1, for example, and then hydrolyzed with water. After evaporating to a low bulk, a powdery solid is obtained that is then subject to hydrothermal treatment in water or aqueous solution. The resulting suspensions contain a certain proportion of functional groups; they are fully aqueous or based on a mix of water and organic solvents.

The production of titanium dioxide nanoparticles through solvothermal synthesis starting from titanium halides or alkoxides with the addition of stabilizing, chelating agents is mentioned in a few publications. H. Kominami et al. (see above) mixed titanium acetylacetonate while adding sodium acetate with ethylene glycol and autoclaved the mixture for 2 hours at 300° C. They added a small quantity of water Between the reaction vessel and the autoclave wall that evaporated at a higher temperature and supported the hydrolysis reaction needed for the titanium compound. With this method, a powder of agglomerated titanium dioxide nanoparticles with Brookite structure was obtained, and its differential thermal analysis showed that organic units still adhered to the particle surface. In photocatalysis, Brookite is a less efficient form of titanium dioxide than anatase, which is the reason why Brookite is not used industrially for this application field.

The preceding overview has shown that in spite of intensive research being done in this field, it has not yet been possible to find out a reliable method for supplying, if necessary, very concentrated dispersions or suspensions of highly crystalline titanium dioxide particles in the lower nanometer range (average diameter up to <30 nm, preferably starting at approx. 5 nm; their dimensions refer to measurements done with the XRD/Scherrer method) that remain stable for a long time in organic solvents.

This would, however, be extraordinarily desirable because particles of the size mentioned above are urgently needed for applications in the field of photocatalytically active surfaces—more specifically, in the form of anatase crystals that exist as storage-stable, highly concentrated dispersions (if need be, as gels as well) and, where appropriate, are re-dispersable after isolation in suitable, essentially non-aqueous, solutions. Solvent-based (if need be, fully anhydrous) stable dispersions of titanium dioxide nanoparticles have a significant advantage over aqueous dipersions for the further processing in solvent-based syntheses, polymer matrices and the like. It should be possible to produce them relatively easy, without mechanical dispersion methods or the addition of dispersion aids, and in a few steps, particularly by avoiding the need for subsequent surface modification, which would make the process economical. It should also be possible to do fully without time-consuming milling and dispersion processes.

Accordingly, it is the first task of the invention to apply a process with which nanoparticle suspensions having the desired combination of properties can be produced and to supply the corresponding suspensions that can be used as such or from which the particles can be separated in powdery form.

As already described, titanium dioxide is a photocatalyst, in which the absorption of photons in the light's UV-A wavelength range initiates the formation of strongly oxidizing charge carriers, which lead to the degradation of the layer matrix through photo-oxidation when the titanium dioxide particles are intermingled in organic coatings and nanocomposites. Consequently, the so-called “chalking” of TiO₂-filled coatings and nanocomposite leads—if need be, under simultaneous discoloration—to the uncovering of the nanoparticles, which lie more or less as loose powder on the surface. It is therefore desirable to improve the UV stability of such coatings and nanocomposites.

For the use of titanium dioxide (anatase, rutile) as white pigment in non-transparent colors, plastics and cosmetics (size of the nanoparticles or their agglomerates>100 nm) there are already suggestions for preventing the photocatalytic decomposition of the surrounding matrices to ensure product UV stability. Some of these suggestions are the incorporation of metallic ions into the crystal lattice and a coating of the pigment surface. Such coatings are already described in U.S. Pat. No. 6,605,147 B2 and the references given therein, in DE 101 53 640 A1, in O. K. Perle et al., Colloids and Surfaces A: Physicochem. Ety. Aspects 257-258 (2005) 261-265 or in A. Jaroenworaluek et al. in Surface and Interface Analysis, Surf. Interface Anal. 2006; 38: 473, for example. Coated TiO₂ particles are often used as UV absorbers in sun creams.

WO 2006/037591 suggests the surface modification of zirconium dioxide particles in particular that can be attained if the particles are subject to mechanical stress in a dispersant with the surface-modifying agents. Many different substances, among them silanes with hydrolyzable and non-hydrolyzable functional groups, are suggested as modification agents.

So far, however, there has been no useful suggestion for how to protect decomposable or at least degradable, transparent and organic plastics or inorganic-organic hybrid polymers filled with titanium dioxide particles from undergoing decomposition through photo-oxidation.

Another task of the present invention is therefore the supply of preferred or especially usable dispersions of highly crystalline particles with adjustable particle size, preferably in the range below 30 nm on the average. The dispersions should have a high proportion of solids and good re-dispersibility of the particles in which the photo-catalytic activity of the titanium dioxide has been modified in such a way that a surrounding organic matrix is not damaged—or at least significantly less than—in the state of the art.

The task of the invention mentioned first is solved by supplying stable dispersions that contain crystalline, surface-modified, nanoscale titanium dioxide particles in organic solvents, and these dispersions are made available through processes that comprise the following steps:
(A) From a soluble precursor prepared through the hydrolysis of complexed titanium halides or alkoxides according to the sol-gel process, a colloid-disperse solution is supplied or produced in organic solvents,
(B) The formed colloid-disperse solution is evaporated to small bulk at about 50° C. to 100° C., preferably at approx. 70° C. to 90° C., for removing non-converted starting materials and highly volatile products. A material that already contains titanium dioxide precursor is formed.
(C-1) The product of step (B) is absorbed in an organic solvent and the resulting solution is autoclaved in a sealed pressure vessel, i.e. heated without pressure compensation. During this step, the advancing thermal hydrolysis and condensation reactions occurring in the presence of small quantities of water (either present in the solvent and/or adhering to the product of step (B) as residual water) form an organic solvent-based dispersion or gel-like mass that contains, in its network, embedded, already surface-modified, crystalline titanium dioxide nanoparticles.
(C-2) Instead, the product of step (B) can be absorbed in water, and
   (C-2-a) the resulting solution is autoclaved in a sealed pressure vessel, i.e. heated without pressure compensation. The advancing thermal hydrolysis and condensation reactions in the presence of small quantities of water (either present in the solvent and/or adhering to the product of step (B) as residual water) form an organic solvent-based dispersion or gel-like mass that in its network already contains embedded, surface-modified, crystalline titanium dioxide nanoparticles, as described in DE 102006032755 A1, whereupon
   (C-2-b) the product of step (C-2) is mixed with an alcohol having preferably 4 carbon atoms, such as n-butanol.

The resulting dispersions can be evaporated to small bulk both in the case of C-1 and of C-2 until a powder is obtained that contains the surface-modified, crystalline titanium dioxide nanoparticles and is easily re-dispersible in organic solvents.

Depending on need, the dispersion/gel/powder can be used directly or, by adding a solvent through mere agitation, converted to (more strongly diluted) nanoparticular dispersion for use.

The advantage of variant (C-1) is that in the nanoparticles produced according to the invention, the customized surface modification is already carried out in situ, and therefore the subsequent surface modification can be eliminated. As opposed to syntheses of titanium dioxide nanoparticles through the thermal treatment of aqueous solutions (product of step C-2), a valuable advantage of this variant is especially the fact that solvent-based, stable titanium dioxide nanoparticle dispersions (product from step C-1) are directly accessible. For the further processing in solvent-based systems, polymer matrices and the like, they have a significant advantage over aqueous dispersions.

The dispersions according to the inventions (product from step C-1), can have titanium dioxide particles in a proportion of up to approx. 35% by weight (roughly 4.4 mol/kg) (measured on the content of crystalline titanium dioxide after annealing of the solutions) or even higher, up to approx. 40% by weight, for example. Preferably, they contain titanium dioxide particles in a proportion of at least 15% by weight, more strongly preferred if they are at least 25% by weight. Naturally, more strongly diluted dispersions can be prepared with the process according to the invention, all the way down to 1% by weight, for example. The concentration of titanium dioxide particles in the dispersions obtained in accordance with step C-2-a are in the order of approx. up to 25% by weight, preferably up to 15% by weight; after evaporation to small bulk, the product from step C-2-b can contain up to 70-85% particles by weight, after re-dispersing of the powder, up to 30% by weight, preferably up to 25% by weight.

Particle size lies in the upper desired range referred to the medium crystallite size (determined with the help of the Scherrer method from the X-ray diffraction diagram at the anatase 101-reflex).

The soluble precursors in step (A) can be present as powders, resins or liquids. Even the products obtained in step (B) after evaporating the solution to a small bulk can have this form. By adding organic solvents (or, less preferably, water) one gets, after just stirring, a transparent colloid-disperse solution that can be colored depending on the starting compounds. The crystalline, surface-modified, nanoscale titanium dioxide particles are therefore preferably present in dispersed form in organic solvents, which can be polar, non-polar and aprotic.

Possible titanium starting compounds can be titanium halides such as TiCl₄ or TiOCl₂ or titanium alkoxides, especially those having the general formula Ti(OR)₄ in which R is a straight-chain, branched or cyclic alkyl radical with preferably 1 to 6 carbon atoms. Examples are titanium ethylate, propylate and butylate. For stabilizing the titanium compounds, chelating agents such as diketones, β-keto-esters, glycol ethers, diols, multivalent alcohols, amino alcohols, glycerin, aminothiols, dithiols, diamines, carboxylic acids, dicarboxylic acids, keto carboxylic acids or keto alcohols or mixtures thereof can be used. In this case, the complex ligand is favorably used in a quantity from 0.5 to 20 mol/mol, preferably 0.5 to 5 mol/mol, referred to the used titanium compound, and preferably added drop by drop to the titanium compound presented while stirring.

Afterwards, the corresponding quantity of water is added drop by drop to hydrolyze the titanium compound. Water is used for this purpose in a preferred concentration (0.5 to 20 mol/mol), but it is even better to add 1 to 10 mol/mol. For the selective control of the hydrolysis and condensation reactions while preparing the soluble precursor, inorganic and/or organic, acidic or alkaline catalysts such as HCl, HNO₃, H₃PO₄, H₂SO₄, NaOH, KOH, NH₃, organic carboxylic, phosphoric or sulfonic acids, amines, etc. can be added to the hydrolysis water in a quantity of up to 1 mol/mol, preferably 0.001-0.3 mol/mol, referred to the used titanium compound.

Furthermore, dissolved salts with metal cations of any elements can be added with the hydrolysis water in a maximum quantity of 15 mole % referred to titanium. The solvo-thermally synthesized titanium dioxide nanoparticles accumulate in this way with foreign ions in doped form. Doping type and concentration, for example, can increase or (if the application requires it) decrease the photocatalytic activity of the titanium dioxide nanoparticles.

Afterwards, highly volatile, non-converted starting materials and formed reaction products are removed in the rotary evaporator at recommended temperatures of 50 to 100° C., better at 70 to 90° C. The residue obtained can be a colorless, yellow to reddish brown powder, a resin or a viscous liquid. This intermediate product can be stored as long as necessary.

The intermediate product is then dissolved by stirring in an organic solvent or solvent mixture and the colloid-disperse solution obtained is subsequently transferred to a pressure vessel. Some alcohols that can be used as solvents are especially the C₁-C₆ alcohols like ethanol, 1-propanol, 2-propanol, butanol or other, less polar solvents like chloroform or toluene or their mixtures. As a rule, it is not necessary to aid the formation and crystallization of the nanoparticles through the addition of a small quantity of water because such (or as far as) a water quantity was already introduced to the reaction medium of the solvothermal treatment with the intermediary product. However, in many cases, a small quantity of additional water has not proven to be detrimental. If ethanol should be used as organic solvent, for example, then it is often unnecessary to use absolute alcohol; the azeotrope form or similar concentrations in the mixture with water are sufficient, but it is recommended for the solvent not to have more than 10% of water by weight and even better if 5% by weight are not exceeded.

The colloid-disperse solutions used for the production of the titanium dioxide nanoparticles according to the invention are characterized by the appearance of a gel-like network when thermal energy is supplied in a closed pressure vessel owing to the advancing hydrolysis and condensation reactions. During the thermal treatment, a nucleation of 4-nm crystalline titanium dioxide nuclei takes place in this gel network that keep growing in the compartments set by the gel network.

The process is characterized by the fact that the size and crystallinity of the nanoparticles can be controlled by the time frame and temperature of the solvothermal treatment. As temperature and time increase, particle/crystallite size increases too. The time frame of this can be a few minutes to several hours, preferably 30 minutes to 20 hours with a temperature range of 70° C. to 300° C., preferably 120° C. to 220° C. The slowly increasing pressure depends on the solvent used; under certain conditions, it can rise all the way to 25 bar. Nanoparticle size can be variably adjusted with the help of the process parameters to be selected and the type of surface modification (owing to the complexing agent(s) selected). Naturally, in each dispersion to be prepared, particle size distribution is in the form of a Gaussian curve.

Time frame and temperature range are adjusted in such a way that the complexing agent furthermore stabilizes terminal titanium atoms on the surface of the nanoparticles and heat does not damage the organic components in the formed gel.

After cooling and opening the pressure vessel, one gets a colorless to reddish brown, glassy shimmering gel or a milky dispersion. These gels or dispersions can be stored in sealed containers and can be re-dispersed if necessary in water or organic solvents just by stirring to obtain colloid-disperse solutions in such solvents, as needed for the respective use. If necessary, these dispersions can be prepared by filtering through filter media with pores having the preferred maximum size range of 1 μm. In addition, the gels or dispersions can be used directly for incorporation into sols, coating formulas and the like. If the application demands it, the dispersions or gels obtained through solvothermal synthesis can also be concentrated further by the removal of highly volatile components, for example through evaporation to a small bulk in the rotary evaporator.

The other task of this invention mentioned can be solved by suppressing the photocatalytic activity of the titanium dioxide. To accomplish this, the particles of the titanium dioxide dispersion are impinged with a thin, oxidic, as a rule transparent (and mostly colorless) shell (preferably of SiO₂, but can also be of ZrO₂, Al₂O₃, ZnO₂, CeO₂, In₂O₃, Y₂O₃, La₂O₃, manganese oxides, iron oxides such as Fe₂O₃, for example, other transition metallic oxides or mixed oxides, especially with the cations of the oxides mentioned earlier), whose surface furthermore underwent an organic surface modification. In the application areas based on the high refraction index of titanium dioxide, this shell can be fully closed, thus fully suppressing the photocatalytic effect of titanium dioxide. In the application area of photocatalytically active coatings and nanocomposites, on the other hand, only an incomplete application of an oxidic shell on the titanium dioxide nanoparticles that acts as spacer for the organic or hybrid polymeric matrix is advantageous. In this case, transparency must be ensured by the excellent dispersibility of the nanoparticles all the way to the primary particle (<30 nm).

In the field of coatings with a highly refractive finish that can be processed in wet chemical methods, the availability of titanium dioxide nanoparticles whose surface is covered with a fully closed, inorganic coating (SiO₂, ZrO₂, etc.) is very important owing to the outstanding physical-chemical properties of TiO₂. It is convenient to have a coating diameter of approx. up to 10 nm, preferably of up to 5 nm.

If possible, the nanoparticles should be in the form of a solvent-based, highly concentrated dispersion. The agglomerate-free incorporation of the core/coating nanoparticles into solvent-based formulations (e.g. varnishes, resins, polymers) can be ensured with a matrix-optimized surface modification (with functionalized silanes, for example); it can lead to special properties (no nanoparticle migration, mechanical strengthening of the matrix while conserving transparency).

A preferred process for creating a corresponding titanium dioxide particle dispersion that contains the core/coating nanoparticles with an organic surface modification comprises the following steps:
(D) A dispersion of a surface-modified titanium dioxide powder made of nanoparticles having a maximum average diameter of <30 nm, preferably a minimum of 5 nm, measured with the XRD/Scherrer method, with high crystallinity in an organic solvent or a mixture of an organic solvent and water is provided. It can be the product of step (C-1) described earlier and/or the one of step (C-2) that was re-dispersed in the solvent/solvent-water mixture mentioned. By adjusting the pH of the solution to <3 or >9, for example, depending on the desired surface modification (with NH₃, HCl, etc., for example), the full deagglomeration of the nanoparticles takes place and a transparent dispersion is obtained.
   The solvent or solution mixture already contains the component (e.g. Si/Zr/Al alkoxides, with chelating ligands or otherwise stabilized alkoxides or salts of these cations) that will form the inorganic shell.
(E) The shell is formed through hydrolysis and condensation reactions of the components that form the oxidic shell while the solution is stirred, preferably over a minimum 12-hour time period. While doing this, the oxide forming the shell displaces the organic constituents with which the modified TiO₂ particles were coated. Nonetheless, the path that makes use of organically modified TiO₂ particles is necessary because they can be easily re-dispersed at the nanoscale level in step (D).
(F) Preferably, the solvent is partially removed from the product of step (E) by evaporating to a small bulk in the rotary evaporator.
(G) The surface modification of the core/shell nanoparticles is done after adding a corresponding component and, if applicable, hydrolysis and condensation reactions while stirring the solution during a preferred minimum time period of 12 hours. By subsequently evaporating the solution to a small bulk in the rotary evaporator, one gets a dispersion that contains core/shell nanoparticles with an organic surface modification that can be diluted or incorporated into organic formulations such as varnishes, resins or polymers by adding organic solvents.

The control of the shell formation, such as the full or incomplete sheathing or thickness of the enveloping layer, takes place in this case by selecting the molar ratio of TiO₂ and the shell-forming components (preferably in the range from 1 to 0.05 to 1 to 0.4, better from 1 to 0.15 to 1 to 0.25), quantity of the solvent (mixture), agitation speed and duration, etc.

When the shell has metallic atoms with d-orbitals, the organic surface modification can then have the same organic groups as the product of step C-1, i.e. especially chelating and other complex ligands. Accordingly, the surface-modifying component that can be added can be mono- or poly-carboxylic acids and especially dicarboxylic acids, activated acid derivatives from it such as acid anhydrides, amino acids, carbonyl compounds, amino acids, amines, diketones and diketonates, keto carboxylic acids, keto alcohols, β-keto esters, glycol ethers, diols, multivalent alcohols, amino alcohols, glycerin, aminothiols, diamines and comparable compounds. Incidentally, regardless of the electronic configuration possibilities of the metallic atoms of the selected oxide shell added for the application of the surface-modifying component, monomers or pre-cross-linked compounds or molecules can be used that carry an organic radical in hydrolytically stable form bound to a metallic atom M capable of forming accessible M-O-M bonds preferably via a hydrolytic condensation reaction. The first ones to be mentioned are silanes, which can have the formula (I)

RₘR′ₙSiX₄₋ₘ₋ₙ (I)

wherein the radicals X can be the same or different and have hydroxy or hydrolytically condensable radicals, especially hydrogen, halogen, alkoxy (as preferred radicals; the especially preferred ones have 1 to 6 or even only 1 to 4 carbon atoms), acyloxy, alkylcarbonyl, alkoxycarbonyl or —NR″, with R″ being hydrogen and/or alkyl, and the R and R′ radicals can be either identical or different. R stands for non-substituted or substituted, straight-chain, branched or cyclic alkyl, alkenyl, alkinyl, aryl, arylalkyl, alkylaryl, arylalkenyl, alkenylaryl, arylalkinyl, wherein the carbon chain can be interrupted, if need be, by oxygen or sulfur atoms or by the —NR″ group, R″ being hydrogen or alkyl. The substitution can be with halogen atoms, for example. The radicals R, in particular, cannot be substituted fully or partially with fluorine. R′ is a radical that is also a non-substituted or substituted, straight-chain, branched or cyclic alkyl, alkenyl, alkinyl, aryl, arylalkyl, alkylaryl, arylalkenyl, alkenylaryl, arylalkinyl that carries one or several, if need be, the same or different reactive substituents, for example for their part non-substituted or substituted amino, amide, aldehyde, keto, alkylcarbonyl, carboxy, mercapto, cyano, hydroxy, alkoxy, alkoxycarbonyl, sulfonic acid, phosphoric acid, acryloxy, methacryloxy, epoxy or urethane groups. m and n can stand for in each case 0, 1, 2 or 3, m+n together can be 1, 2 or 3. Examples of radicals R are methyl, ethyl, longer-chained alkyles, phenyl, radicals containing vinyl groups, norbonenene groups or radicals that carry a mesogenic group over a spacer, for example an alkylene chain. Examples for R′ radicals are groups that for their part can be organically polymerized or can enter into an organic condensation reaction, e.g. radicals containing vinyl or allyl groups, (meth-)acrylic acid, carboxylic acids, acetate, cyanate, radicals containing one or several free hydroxy, carboxy or amino groups or epoxides. In preferred embodiments, m=1 and/or n=1. Silanes having the formula (I) with m+n=1 and X=alkoxy, especially methoxy or ethoxy, are especially preferred.

In principle, the length of the carbon chains in the mentioned radicals is unrestricted: preferred are 1 to 25, more preferred 1 to 15 carbon atoms for aliphatic chains, and 6 to 50 (better: all the way to 25) carbon atoms for aromatic systems.

If the desire is not to apply too many organic groups on the surface, the silanes mentioned above that have metallic compounds with the formula M^{a}(X)ₐ can be “diluted”, in which case trivalent (a=III, 3) and tetravalent (a=IV, 4) metals M are suitable with hydrolytically condensable radicals X, and X is defined, as above, for the silane of formula (I), preferably an alkoxy radical. Examples of these metallic compounds are tetralkoxysilanes, trialkoxyaluminates and the like.

In particularly preferred embodiments, the surface modification is selected in such a way that the particles are worked in without agglomerates in organic or hybrid polymeric formulations, e.g. varnishes, resins or polymers from pure organic or inorganic-organic polymers (among them especially organically modified silicon (hetero) polycondensates are to be expected) and, if need be, polymerized or cross-linked with the formulation in this process. Many silicon (hetero) polycondensates have been described and they are especially known as ORMOCER®s. Instead of naming many documents where they are described, reference will be made to the review of G. Schottner “Hybrid Sol-Gel-Derived Polymers: Applications of Multifunctional Materials” in Chem. Mater. 2001 (13), 3422-3435. The materials are suitable for numerous applications such as the manufacturing of (massive) bodies, coatings and fibers so they can acquire the most varied properties with their help. Special reference will be made to highly scratch-free, often transparent coatings and bodies with high refractive indices where appropriate.

The organic surface modification of the particles can take place, for example, with the help of functional silanes adapted to the respective matrix through the selection of a functional group (for example, alkyl silanes for hydrophobic, organic matrices without reactive binding, acrylate or methacrylate groups for the reactive binding to UV-interlaced, organic polymers or nanocomposites, amino silanes or epoxy silanes for the reactive binding to thermal interlacing organic polymers or nanocomposites). Examples for such organic or hybrid polymer formulations are thermosetting plastic resins or—better—thermoplastics from the polyamide carbonates, ethylenes, proplyenes, acrylates, methacrylates, vinyl chlorides, acetates, ketones, urethane group, for example, as well as the corresponding copolymers. The invention is particularly interesting for transparent materials, as already described above.

The invention will now be explained in more detail with the help of execution examples.

### EXECUTION EXAMPLE 1

Under agitation, 1.5 mol 2-(2-methoxy ethoxy)acetic acid are added drop by drop with a dropping funnel to a 2-L round bottom flask that has 0.6 mol titanium tetraethylate. The solution is stirred further for 1.5 hours and subsequently hydrolyzed with the addition of 10 mol water. After the full removal of all volatile constituents in the rotary evaporator at a water bath temperature of about 85° C., a resin-like product is obtained.

In a 100-mL screw-cap vessel, 17.5 g of the resin-like product is dissolved after adding 42.5 g ethanol while stirring. After a clear solution has been obtained, it is transferred to a Teflon vessel, which is closed with a sealing ring and lid and placed inside a closed autoclave. The autoclave is placed in a forced-air oven, which is heated up to 160° C. and left inside for another 4 hours. After this time has elapsed, the autoclave is taken out, opened after it has cooled off and the white-colored, gelatinous mass obtained is transferred to a closable, airtight screw-cap vessel. The white, gelatinous mass contains titanium dioxide nanoparticles with a mean crystallite size of 9 nm.

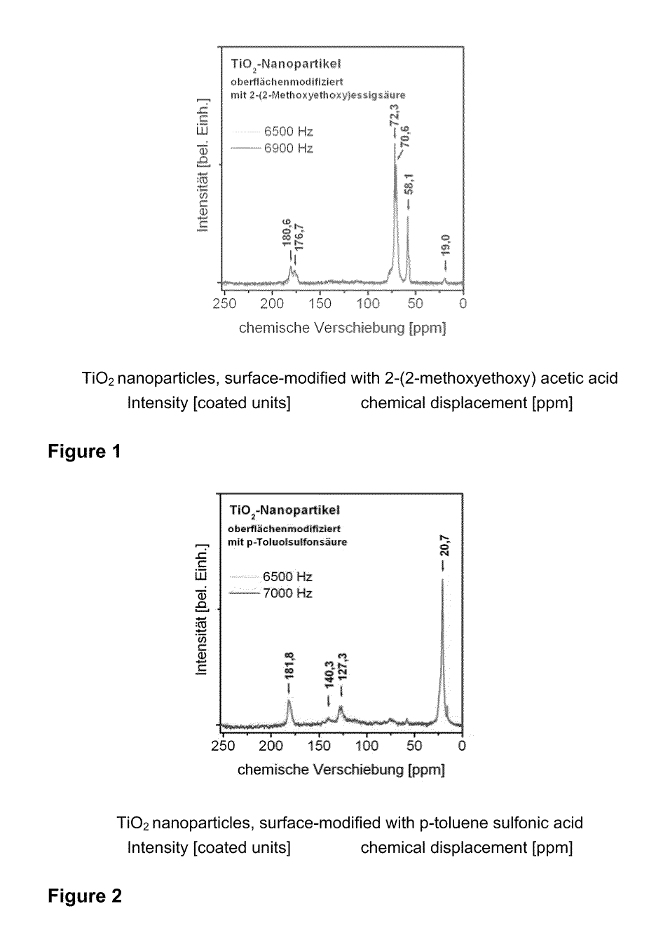

The ¹³C-VACP/MAS NMR spectrum of a TiO₂ nanoparticle powder modified with 2-(2-methoxyethoxy)acetic acid produced according to the process of example 1 is shown in FIG. 1.

### EXECUTION EXAMPLE 2

1.5 mol titanium tetraethylate are added to a 2-L round bottom flask and afterwards 1.0 mol acetylacetone are added drop by drop with a dropping funnel while stirring. The solution is further agitated for 1.5 hours and subsequently dissolved by adding 0.10 mol p-toluene sulfonic acid and hydrolyzed in 10 mol water. After the full removal of all volatile constituents in the rotary evaporator at a water bath temperature of about 85° C., a powder is obtained.

In a 1000-mL screw-cap vessel, 221.5 g of the powder (TiO₂ oxide content: 55.2% by volume) are dissolved after adding 799.2 g ethanol while stirring. Once a clear solution has been obtained, it is transferred to a Teflon vessel, which is closed with a sealing ring and lid and placed inside a closed autoclave. The autoclave is placed in a forced-air oven, which is heated up to 160° C. and left inside for another 16 hours. After this time has elapsed, the autoclave is taken out, opened after it has cooled off and the white-colored, gelatinous mass obtained is transferred to a closable, airtight screw-cap vessel.

The ¹³C-VACP/MAS NMR spectrum of a TiO₂ nanoparticle powder modified with p-toluene sulfonic acid produced according to the process of example 2 is shown in FIG. 2.

### EXECUTION EXAMPLE 3

21.75 g of the gelatinous mass of example 2 are mixed in a mixture of 400 g ethanol, 1.99 g tetramethoxysilane, 725.23 g water and re-dispersed with 16.17 g of 25% NH₄OH solution (pH≈9-10) and stirred afterwards overnight. The colloidal solution obtained is evaporated to one-half of the bulk and 6 g of 3-glycidyloxipropyltrimethoxysilane added to it. After renewed overnight agitation, it is evaporated to a small bulk until an approx. 6% dispersion (an TiO₂) is obtained, which is in turn obtained as a meat-colored, gelatinous mass that can be absorbed in organic solvents for further processing or can be incorporated free of agglomerates into organic and hybrid polymer formulations (for example, varnishes, resins, polymers).

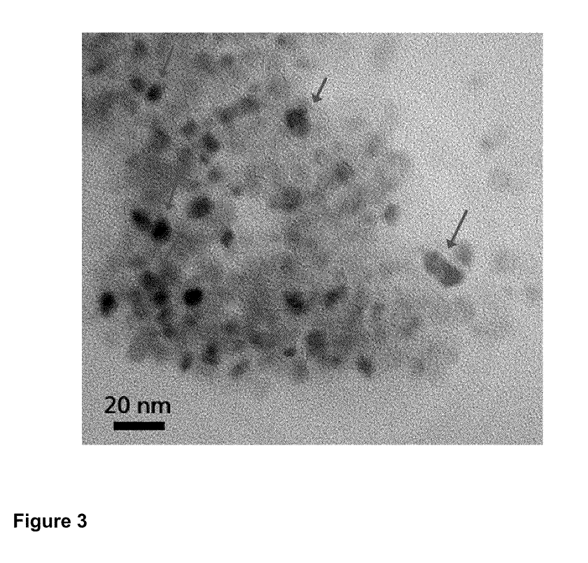

FIG. 3 is a transmission electronic microscope image of TiO₂/SiO₂ core/shell nanoparticles (the clearly recognizable shells are indicated with arrows).

1. Particles with a titanium dioxide crystalline core that have an average diameter of ≦30 nm measured with the XRD/Scherrer method, a metal oxide shell that has no photocatalytic properties and an outer skin that carries organic radicals.

2. Particles according to claim 1, wherein the metallic oxide is SiO₂.

3. Particles according to claim 1, wherein the organic radicals of the outer skin have been selected from among a straight-chain, branched or cyclic alkyl, alkenyl, alkinyl, aryl, arylalkyl, alkylaryl, arylalkenyl, alkenylaryl, arylalkinyl bound through a carbon atom, non-substituted or substituted with a halide, especially fluorine, or with one or several reactive radicals that for their part are or carry non-substituted or substituted amino, amide, aldehyde, keto, alkylcarbonyl, carboxy, mercapto, cyano, hydroxy, alkoxy, alkoxycarbonyl, sulfonic acid, phosphoric acid, acryloxy, methacryloxy, epoxy or urethane groups or are mixtures of these groups and whose carbon chain is continuous or can be interrupted by oxygen or sulfur atoms or by the radical —NR″, where R″ equals hydrogen or alkyl.

4. Particles according to claim 3, wherein the outer skin is present as a monomolecular Layer, preferably as a metal oxide layer whose metal atoms are fully or partially substituted with at least one group as defined in claim 3.

5. Particles according to claim 1, wherein the metal oxide shell without photocatalytic properties surrounds the core fully, preferably with a thickness of up to 10 nm, more preferably with a thickness of up to 5 nm or that it surrounds the core only partially.

6. Process for the production of particles according to claim 1 comprising the following steps:
(D) Supply of a dispersion with crystalline titanium dioxide particles, whose surface has been modified with organic groups having an average diameter of ≦30 nm, in a solution that contains a dissolved, hydrolytically condensable compound of a metal M whose oxide should make up the mentioned shell, in which case an organic solvent or a mixture of an organic solvent and water is used, and the pH of the solution is adjusted in such a way that a full deagglomeration of the nanoparticles takes place;
(E) Movement of the dispersion in the presence of sufficient quantity of water for the hydrolytical condensation of the dissolved, hydrolytically condensable compound of the metal M until the organic constituents with which the modified TiO₂ particles were coated are displaced and an oxidic shell of the metal M is formed;
(F) Preferred is at least the partial removal of the solvent/water from the product of step (E); and
(G) Addition of a component that modifies the surface of the oxidic shell to the product of step (F) and causing the formation of an outer skin that has organic groups, and with the help of this component on the particles, in which case one obtains a dispersion of surface-modified particles.

7. Process according to claim 6, wherein the hydrolytically condensable compound of the metal M has been selected among alkoxysilanes.

8. Process according to claim 6, wherein the surface-modifying component of the oxidic shell has been selected from among metallic compounds that carry an organic radical through a carbon atom bound to metal atoms M of this compound and a hydrolytically condensable radical, and wherein it encompasses the causing of the formation of an outer skin that has organic groups, the dissolution of these components in water or in a solvent that contains enough water for the hydrolytic condensation of these components, and the deposition of the hydrolyzed compound in form of a condensate on the surface of the particles.

9. Process according to claim 8, wherein the metallic compounds that carry an organic radical through a carbon atom bound to metal atoms M and a hydrolytically condensable radical are selected from among silanes having the formula (I)
RₘR′ₙSiX₄₋ₘ₋ₘ (I)
wherein X is the same or different and is a hydrolyzable radical, especially an alkoxide, in the presence of water and, where applicable, a catalyst, R is the same or different and stands for a non-substituted or substituted, straight-chain, branched or cyclic alkyl, alkenyl, alkinyl, aryl, arylalkyl, alkylaryl, arylalkenyl, alkenylaryl, arylalkinyl, wherein the carbon chain can be continuous or interrupted by oxygen or sulfur atoms or by the —NR″ group, where R″ equals hydrogen or alkyl, R′ is the same or different and stands for a non-substituted or substituted, straight-chain, branched or cyclic alkyl, alkenyl, alkinyl, aryl, arylalkyl, alkylaryl, arylalkenyl, alkenylaryl, arylalkinyl that carries one or several, where applicable the same or different substituents, selected from among substituents that, in turn, are or carry non-substituted or substituted amino, amide, aldehyde, keto, alkylcarbonyl, carboxy, mercapto, cyano, hydroxy, alkoxy, alkoxycarbonyl, sulfonic acid, phosphoric acid, acryloxy, methacryloxy, epoxy or urethane groups, m and n meaning in each case 0, 1, 2 or 3 and m+n together being 1, 2 or 3.

10. Process according to claim 6 comprising the removal of solvents and water from the product of step (G) and the drying of the powder obtained.

11. Process according to claim 6, wherein the dispersion of titanium dioxide particles with an average diameter of ≦30 nm whose surface was modified by organic groups is prepared according to the steps described below:
(A) Supply of a colloid-dispersed solution prepared through the hydrolysis of complexed titanium halides or alkoxides according to the sol-gel process from soluble precursors in an organic solvent;
(B) Evaporating the solution formed according to (A) to a small bulk at a temperature range of 50° C. to 100° C. for removing non-converted starting materials and highly volatile products; and
either
(C-1) Absorb the product of step (B) in an organic solvent, thereby forming a solution, and autoclaving this solution in a sealed pressure vessel; or
(C-2) Absorb the product of step (B) in water, thereby forming a solution, and autoclaving this solution in a sealed pressure vessel, in which case a water-based dispersion or gelatinous mass contains in its network embedded, to a certain extent already surface-modified, titanium dioxide nanoparticles and the subsequent absorption of this dispersion in an alcohol.

12. Use of the particles according to claim 1 as fillers in an organically- or inorganically-organized polymer matrix used for manufacturing an object or coating that can be applied as an internal or external coating of a layer system or that has the form of the known object or comes from the coating mentioned.

13. Use of the particles according to claim 12, wherein the organic radicals of the outer skin have been selected from among a carbon atom-bound straight-chain, branched or cyclic alkyl, alkenyl, alkinyl, aryl, arylalkyl, alkylaryl, arylalkenyl, alkenylaryl, arylalkinyl, substituted with one or several reactive radicals that carry/carries one or several groups selected from among amino, amide, aldehyde, keto, alkylcarbonyl, carboxy, mercapto, cyano, hydroxy, alkoxy, alkoxycarbonyl, sulfonic acid, phosphoric acid, acryloxy, methacryloxy, epoxy and urethane groups, and whose carbon chain is continuous or can be interrupted by oxygen or sulfur atoms or by the —NR″ group, where R″ equals hydrogen or alkyl, rather than as through a reaction with the reactive groups of the organic or inorganic-organic polymer matrix that can be organically integrated or bound particles to this matrix.

14. Use according to claim 12 wherein the particles serve as fillers of organic or inorganic-organic (hybrid) matrices intended for the manufacturing of lenses or other optical articles or for objects that can be used in photocatalysis or as fillers for the lenses manufactured from the matrices or other optical articles or objects that can be used in photocatalysis.

15. Process for preparing a dispersion of titanium dioxide particles whose surface is coated with organic groups and that have an average particle size range of ≦30 nm measured with the XRD/Scherrer method, comprising the following steps:
(A) Supply of a colloid-dispersed solution that was prepared through hydrolysis of complexed titanium halides or alkoxides according to the sol-gel process from soluble precursors in an organic solvent;
(B) Evaporation to a small bulk of the solution prepared according to (A) at a temperature range between 50° C. and 100° C. for the removal of non-converted starting materials and highly volatile products;
(C) Absorption of the product of step (B) in an organic solvent, thereby forming a solution, and autoclaving this solution in a sealed pressure vessel; whereby
the absorption of the product and the autoclaving take place preferably in an organic solvent that contains no more than 10% of water by weight, more preferably no more than 5% of water by weight, and even more preferably no more than 2.5% of water by weight; and/or
the autoclaving takes place preferably in the absence of additional water.

16. Particles according to claim 1, in which the titanium dioxide is present in the anatase or rutile modification.
